(19) United States
(12) Patent Application Publication
(10) Pub. No.: US 2019/0080587 A1
(43) Pub. Date: Mar. 14, 2019

(54) Left-Behind Telephone Reminder System and Method

(71) Applicant: Jeffrey Alan Greenberg, Princeton, WV (US)

(72) Inventor: Jeffrey Alan Greenberg, Princeton, WV (US)

(21) Appl. No.: 15/703,731

(22) Filed: Sep. 13, 2017

(51) Int. Cl. G08B 21/24; H04W 4/80; H04B 1/3827; H04W 8/00

(52) U.S. Cl. CPC G08B 21/24; H04W 4/80; G08B 3/10; H04W 8/005; H04B 1/385

(57) ABSTRACT

A system and method for preventing leaving a cellular telephone behind that includes a portable device which contains a pairable transceiver such as a BLUETOOTH™ transceiver that can pair with another pairable transceiver in a cellular telephone. The cellular telephone alarms with a particular ring tone when the portable device which the user carries typically on a key chain when pairing between the portable device and the telephone is broken by the user moving out of range of the telephone.

### BACKGROUND

### Field of the Invention

The present invention relates generally to the field of electronic reminder devices and more particularly to a device that reminds a user they have left their handheld telephone behind.

### Description of the Prior Art

In this day when almost everyone carries a handheld telephone, it is very common to place the phone somewhere, and then later to leave without it. This is annoying and can result in loss of important calls or communications.

There have been a few attempts to remedy this in the past.

In U.S. Published Patent Application number 2003/0073036, Merrem teaches a PDA protection system that alerts the user if the user is spaced more than a predetermined distance from the PDA. The invention places a transmitter in the PDA and uses a small portable receiver.

In U.S. Published Patent Application number 2007/0129113, Klicpera also teaches a system that alerts a user that he or she is separated more than a predetermined distance from a cellphone. The invention uses bidirectional communication between the cellphone and a portable device. The portable device alarms when a predetermined the distance is exceeded.

Both of the above systems use received signal level as an indicator of distance and cause the portable device to alarm. It would be advantageous to use some other factor besides a measure of received signal as a distance indicator since it is very difficult to accurately measure signal strength, and from it determine distance, and it would be advantageous to have the telephone alarm with a ring tone. This allows the portable device to be very small, contain no expensive processor or software, and to use very little battery power.

The prior art also signals continuously between the PDA/phone and the portable device. This can use considerable battery power at both ends of the link. It would be advantageous to have a system that turned on and off on a timer to conserve battery power.

### SUMMARY OF THE INVENTION

The present invention relates to a system and method for notifying a phone owner that they have left their cellphone behind. The invention avoids the necessity of having a complex piece of equipment in the portable device. In one embodiment, the portable device only needs to contain a battery and a radio pairing transceiver chip (such as a well-known BLUETOOTH™ chip). The entire intelligence of the system can reside in an application (APP) that is down-loaded and executes on the telephone. Since every cellular telephone today has factory-supplied BLUETOOTH capability, and every telephone has a variety of ring tones available, the telephone itself can communicate with the portable device (which can be attached to a keychain or the like) using BLUETOOTH or another pairing system and alarm when pairing is broken by the portable device being too far away from the telephone. This allows the portable devices to be very small, use very low power and be very low cost to manufacture and mass produce. The base range of BLUETOOTH is known to be around 10 meters or 33 feet. This range can be adjusted with an attenuator or a sub-optimum antenna to between 8 and 20 feet. A telephone ringing an alarm can be easily heard at 20 feet. Yet this is far enough away that the user has probably forgotten the telephone. In an alternate embodiment, in order to conserve battery power, the remote device or the APP or both can turn off, only turning on periodically (say every 15 or 20 seconds) so that the phone can check that the remote device is still in range. By conserving battery power, the remote device can contain a small non-rechargeable battery further reducing cost and complexity.

### DESCRIPTION OF THE FIGURES

Attention is now directed to several drawings the illustrate features of the present invention.

FIG. 1 shows a cellular telephone being left behind (using stick figures) where the telephone alarms.

FIG. 2 shows a range map for a paired radio system.

FIG. 3 shows a cellular telephone being left behind where the portable device alarms.

FIG. 4 shows a block diagram of an embodiment of a portable device.

FIG. 5 shows a block diagram of an embodiment of FIG. 4 with a re-chargeable battery.

FIG. 6 shows a flow-chart of an application APP for the cellular telephone.

FIG. 7 shows an alternate embodiment of a portable device with an enunciator.

FIG. 8 shows an alternate embodiment of a portable device with a timer.

Several figures and illustrations have been provided to aid in understanding the present invention. The scope of the present invention is not limited to what is shown in the figures.

### DESCRIPTION OF THE PREFERRED EMBODIMENTS

The present invention relates to system and method for preventing a user from leaving a cellular telephone behind. The system includes two components: 1) a down-loadable application (APP) for the cellular telephone, and 2) a small portable device that can be carried on a key chain or the like.

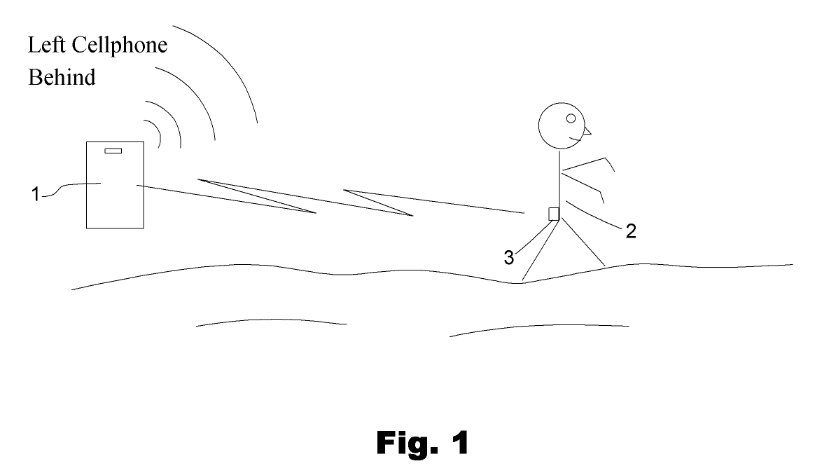

FIG. 1 shows a stick diagram of a person 3, leaving a cellular telephone 1 behind. The person 3 carries a small portable device 2 that radio pairs with a pairing transceiver in the telephone (such as a BLUETOOTH™ chip). The telephone alarms with a ring tone when the paring system loses pairing (pairing is broken). A special ring tone may be chosen to indicate that pairing is broken, or a standard ring may be used. This can be made optional in the APP on the telephone.

Since almost all cellular telephones today have BLUETOOTH capability, the portable device 2 can be as simple as a powered BLUETOOTH chip in a small enclosure. This is very easy and low cost to mass produce. Each BLUETOOTH chip has its own unique identification (ID), so all that is necessary to initialize the system is to allow the devices to pair, and then enter data into the APP that this is the correct pairing (since the phone may pair with other BLUETOOTH devices as well).

The first time a portable device is used, it must be paired with the telephone APP. To do this, the APP is started on the phone. The portable device must then be put into a Discovery Mode. This is an option on a BLUETOOTH chip and can be initiated by holding a button on the remote device. The portable device and the phone should be near one-another. The APP will then pair with the portable device. The APP can ask the user if the device that just paired is to be the know range device. After that, the APP recognizes this particular device from then on and pairs with it whenever it is brought into range.

While BLUETOOTH is the preferred data link between the telephone and the portable device, any other pairing system may be used such as ANT+ or other systems. The link may be radio, as in the case of BLUETOOTH, or by other means such as infrared light or acoustical signals. The term “pairable transceiver” is defined as a radio transceiver that contains a protocol that allows it to pair with another similar radio transceiver forming a pico-net. A BLUETOOTH radio chip is an example of a pairable transceiver. “Pairing” or “to pair” is defined to mean a protocol exchange between two pairable transceivers that allows each to recognize the other and communicate with one-another. “Pairing is broken” means that two pairable transceivers that were paired are no longer paired. A “discovery mode” is a mode where a pairable transceiver transmits data that allows another pairable transceiver to pair with it.

BLUETOOTH and similar systems operate in the low power, unlicensed Industrial, Scientific and Medial (ISM) frequency bands around 2.4 GHz. Basic BLUETOOTH and similar systems are class 2 radio systems that run not more than 2.5 mW effective radiated power and have a free-space range of around 10 meters with an optimum antenna. In practical situations where the telephone might be located (in a room, in a car or the like), the true range may be considerably less due to local shielding, reflections and attenuation. A range of 10-15 feet is typical. This distance, up to the theoretically maximum of 33 feet (10 meters) is ideal for the present invention. In embodiments where the alarm goes off upon loss of pairing, this would be the range that would alarm. To get closer ranges, it is necessary to measure received signal strength to determine when to alarm, or to reduce the power of the pairable transceiver in the portable device using either direct power control to the chip, an attenuator or a sub-optimum antenna. This is particularly true if higher power pairable transceivers are used such as more advanced BLUETOOTH chips. While measurement of signal strength to determine distance is a possibility, it is less sure than loss of pairing. In those embodiments that measure the signal strength, the signal strength of the portable device is determined by the APP in the telephone. This requires a more complicated use of the application interface (API) on the telephone and more complex software rather than simply sensing when simply pairing is lost.

The basic BLUETOOTH standard requires a minimum free-space range of 10 meters (33 feet); however, as stated, this can be reduced to a lower free-space range at the telephone receiver by setting the power level of the portable device transmitter to less than 2.5 mW, or by using a sub-optimum antenna, by using an attenuator, or by using some shielding in the portable device. With one of these techniques, the free-space range can be reduced to 8-20 feet. BLUETOOTH can be used in a basic rate point-to-point configuration (which transmits continuously), or a low energy LE mode that transmits in bursts greatly conserving battery power. Any mode that pairs two devices may be used.

When two pairing transceivers begin to communicate at the physical level, that exchange a protocol with one-another that results in a pico-net being established between the devices. Two devices in such communication are said to be paired as previously stated. That means, that at the physical level, they are sending and receiving frequency-hopping, or other, signals that are synchronized and compatible, and at the protocol level, they have identified each other and can transmit data. Usually, one of the devices is designated as a master, while the other is designated as a slave. In the present invention, the telephone is usually the master device. In some systems, both devices are on equal footing.

When the telephone is brought into range of the portable device's pairable transceiver, the two devices perform a protocol exchange and the telephone pairs with the portable device. The telephone APP has been set up to recognize that particular pairing as the one that signals distance between the telephone and the portable device (which can be on the user's key chain or elsewhere in his possession). This logical relationship is established when the portable device is paired with the telephone the first time. After that, pairing will occur whenever both the telephone is turned on (and the APP is running), and the portable device is within range. Once pairing has taken place, the telephone continually monitors to see if pairing is ever broken (by the portable device moving out of range). If this happens, the APP in the telephone causes the phone to ring with a particular ring tone signaling that the user has left the vicinity of the telephone leaving the phone behind. After a predetermined amount of such ringing, the APP can silence since further ringing is non-productive. The APP can also silence the phone ringing if the portable device comes back into range and re-pairs (usually meaning the user came back for the forgotten phone).

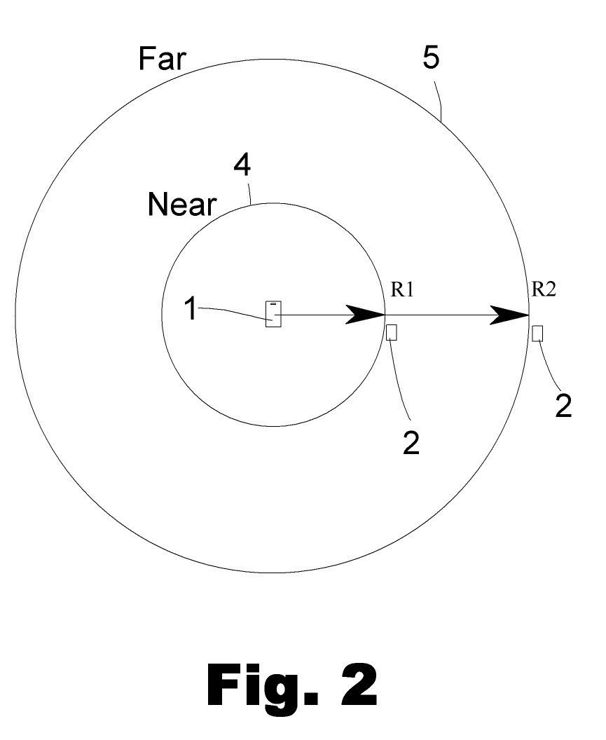

FIG. 2 is a range diagram showing two possible ranges: a NEAR range R1 4 and a FAR range R2 5. The NEAR range R1 is typically approximately eight feet, while the FAR range R2 is typically 16-20 feet. A third range R3 (not shown) is the full free-space range of 10 meters (33 feet) for typical 2.5 mW basic pairable transceivers. These various ranges are determined by the radiated power of the portable device, which as has been described, can optionally be set by the user using a button or switch on the portable device that can typically switch in an attenuator or directly change power from the chip.

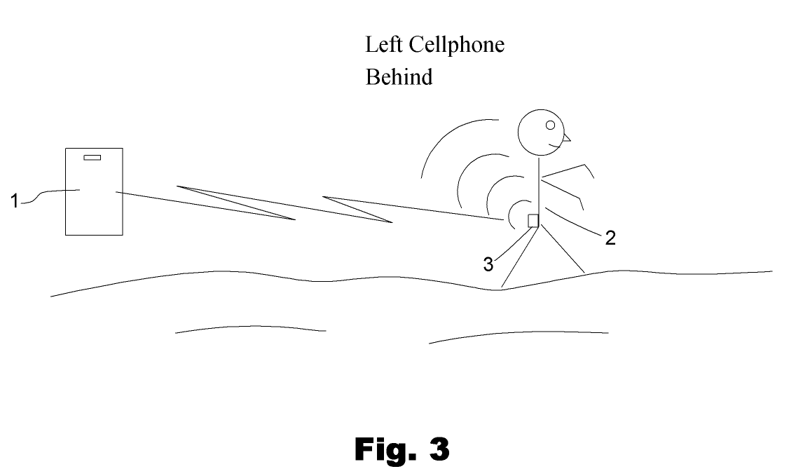

FIG. 3 shows an alternate embodiment of the present invention where the portable device alarms instead of the telephone when pairing is lost. This embodiment requires an enunciator and either a logic circuit to trigger the enunciator or a small processor or controller. Because this embodiment is more expensive to manufacture (more parts and more complexity), embodiments where the telephone alarms are preferred.

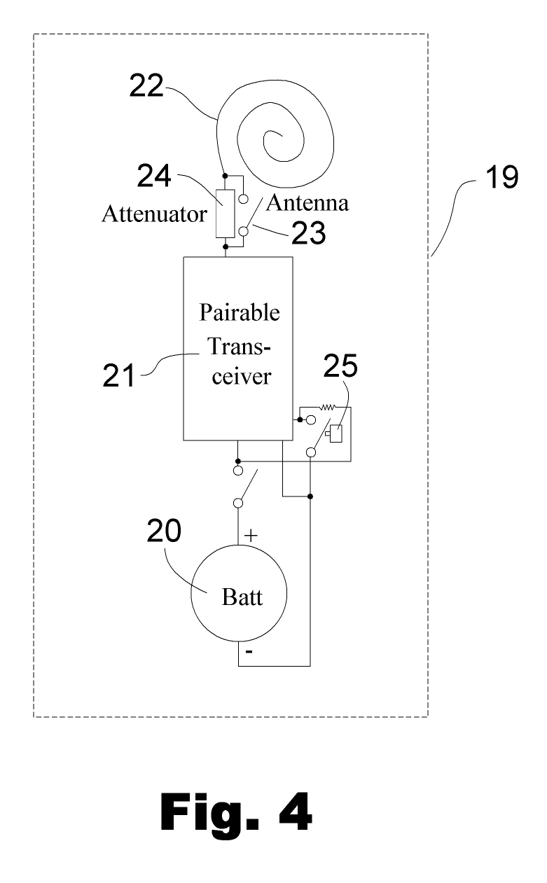

FIG. 4 shows a block diagram of an embodiment of a portable device of the present invention. A housing 19 contains a battery 20 that powers a pairable transceiver 21 (which can be a BLUETOOTH basic radio chip in the preferred embodiment). The pairable transceiver is coupled to an antenna 22 through an optional switch 23 that can switch an attenuator 24 in or out. The attenuator 24 can be a well-know radio frequency (RF) attenuator that causes the RF signal to pass through a length of lossy material. Any type of RF attenuator may be used. In lieu of an attenuator, a sub-optimum antenna or partial shielding may be used as previously stated. A sub-optimum antenna can be one that is mismatched to the pairable transceiver resulting in a higher than optimal standing wave ratio. This results in less radiated power. Since this could cause the chip to overheat, an attenuator is preferred.

A button 25 causes the pairable transceiver to go into a “Discovery Mode” in which it continuously transmits according to a protocol so that another pairable transceiver can pair with it. This switch is shown with a pull-up resister in FIG. 4. This resistor is optional; the system can be pull up or pull down depending upon the requirements of the pairable transceiver chip. In this case, the other pairable transceiver is the transceiver in the telephone. Typically, the button 25 must be held down for several seconds to initiate Discovery Mode. If Discovery Mode is entered after pairing has occurred (by inadvertently holding the button 25 down), the APP can ignore the device since they are already paired.

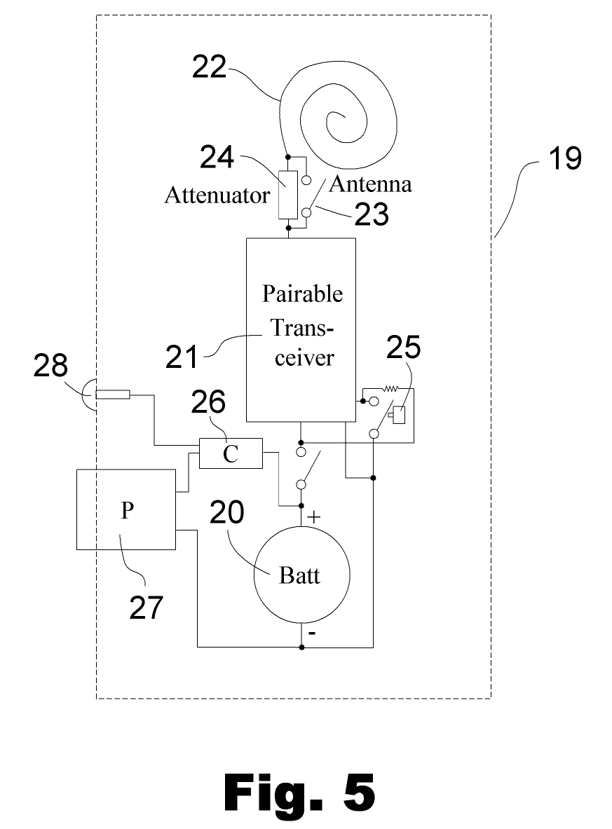

The portable device shown in FIG. 4 can be made very small and constructed to be held on a key chain. The battery 20 can be a small button battery (which needs to be replaced occasionally), or it can be a rechargeable battery with a charger port. The ability to charge the battery 20 in the way the telephone is charged means the battery does not typically need replacing, but makes the device larger and slightly more expensive to manufacture. There also must be some circuitry to recharge the battery. FIG. 5 shows a block diagram of an embodiment of a portable device with a rechargeable battery. Here the battery 20 is a rechargeable battery with charging circuitry 26 and a charging port 27 that can be a mini-USB port known in the art of other type of port. An optional charging light 28 can also be attached to the housing 19.

An off-on switch is shown in FIGS. 4-5. The portable device can be turned off when not in use to save battery (at night for example). However, because of the danger of forgetting to turn it on, the switch may optionally be eliminated, or it can be of the type that turns itself on with the first motion (acceleration) such as the user picking it up.

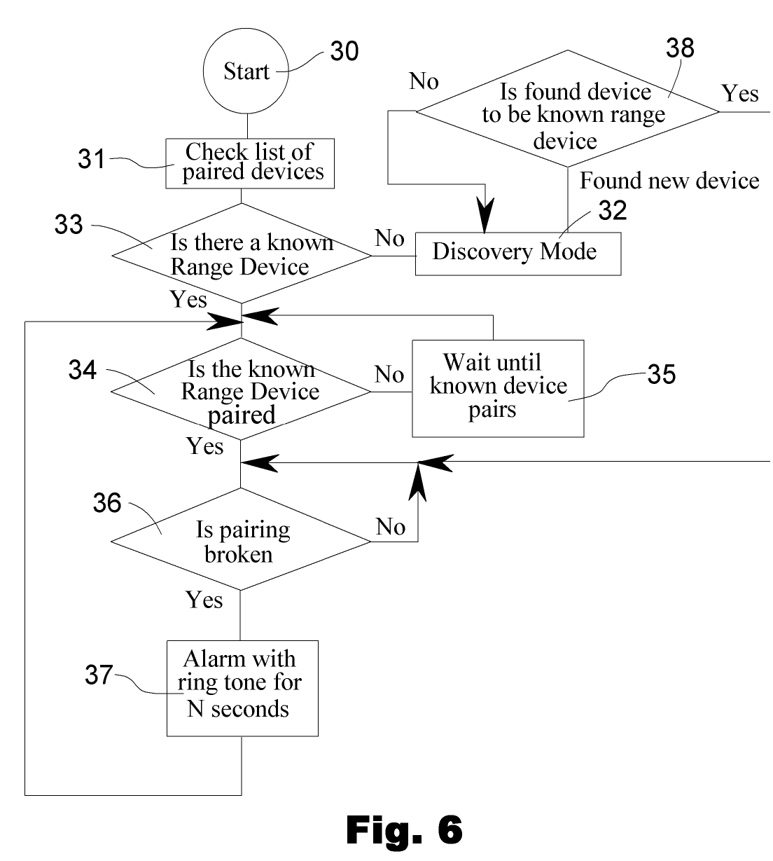

FIG. 6 shows a flow chart for a typical application APP that can be down-loaded into a cellular telephone as is known in the art. The APP includes instructions that are stored in a memory in the telephone and executed on a processor in the telephone. The memory in the telephone also stores data. The APP in FIG. 6 uses the telephone ring tone as an alarm.

When the APP is started 30, a list of all paired devices is checked 31. The question is asked if there is a known portable device that has been designated as a range device 33. If there is no known portable device (this is the first time the APP has been used, or this is the first time for a new portable device), the telephone pairable transceiver begins to search for a new device in a discovery mode 32. When a new device pairs, the user can be asked 38 on the screen if this is to be the range device. If not, the flow returns to discover mode and keeps looking. If so, the flow skips the next step 34 and moves to step 36. In the typical case that there is a known range device in step 33, the system asks if that device is paired 34. If not, the system waits until it pairs 35 (this wait might occur if the APP is started with the portable device out of range or turned off). If the known range device is paired, the flow moves to step 36. Step 36 is the main system loop. Here, nothing happens as long as the portable device (the known range device) is paired meaning that the portable device is within the specified range of the telephone. The system remains in loop 36 until the pairing is broken (or the APP is shut off). If pairing is broken (meaning the user has moved the portable device out of range of the telephone), the telephone alarms 37 for a prescribed number of seconds. This duration can optionally be chosen by the user when the APP starts, or it can be fixed. A preferred duration is approximately thirty seconds; however, any duration is within the scope of the invention.

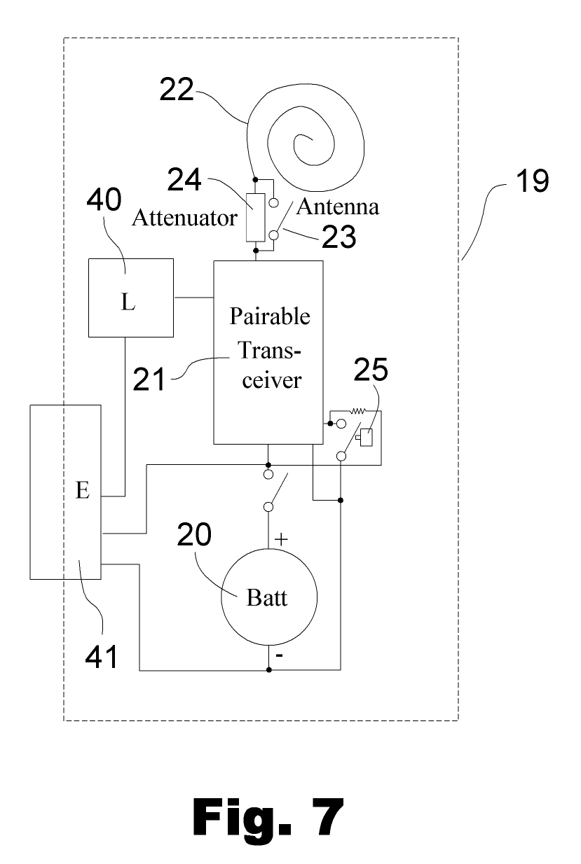

In an alternate embodiment, the portable device can alarm as shown in FIG. 3 instead of the telephone as shown in FIG. 1. FIG. 7 shows a block diagram of that embodiment. Here, pairing occurs in the same manner; however, logic 40 in the remote device initiates an alarm on an enunciator 41 located in the remote device. This enunciator 41 can be a ringer, bell, alarm, vibrator or any other type of enunciator that can get the attention of the user. The alarm occurs upon an electrical signal from the pairing transceiver 21 indicating that pairing is broken.

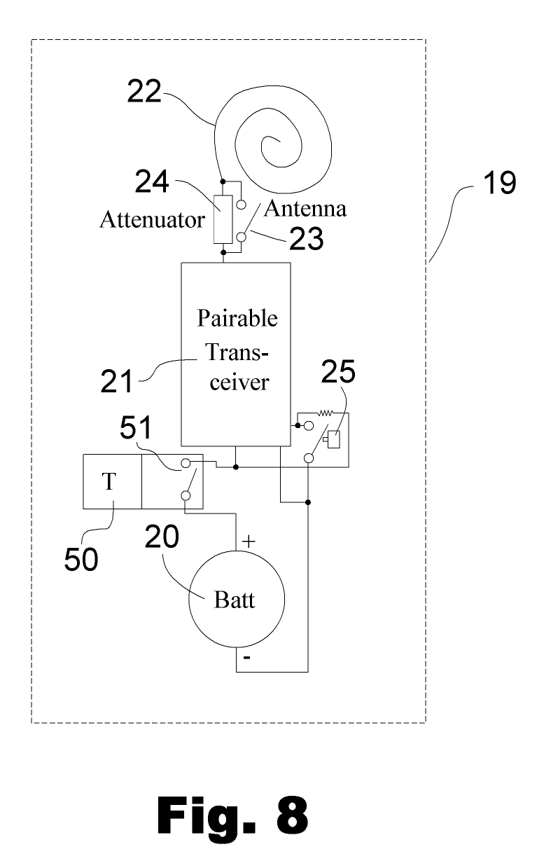

Because battery drain is a major concern, an alternate embodiment of the present invention turns off the portable device pairable transceiver in a repeating cycle. Since the portable device can pair with the telephone in a few seconds, the APP can be modified to allow the portable device to turn off for a small period such as 10 seconds and then turn back on, pair and wait around 5 seconds. In this case, the APP in the telephone delays the alarm upon a broken pair for about 15 seconds while it waits for the portable device to turn back on and re-pair. Failure to re-pair within 15 seconds causes the alarm as usual. This scheme, while more complex at the portable device end, provides a considerably longer battery life. The portable device requires a hardware timer that runs continuously. However, this timer uses much less power than the 2.5 mW transmitter in the pairable transceiver. The times given in this paragraph are for example only. Other times and durations may be used. FIG. 8 shows a block diagram of a portable device with a timer 50.

The system and method of the present invention provides a convenient way to avoid leaving one's cellular telephone behind.

Several descriptions and illustrations have been presented to aid in understanding the present invention. One with skill in the art will realize that numerous changes and variations may be made without departing from the spirit of the invention. Each of these changes and variations is within the scope of the present invention.

1. A system to prevent leaving a telephone behind comprising:
a portable device including a pairable transceiver coupled to an antenna through an attenuator, the attenuator chosen to determine a predetermined range for the pairable transceiver;
a battery in the portable device powering the pairable transceiver;
a set of executable computer instructions storable in a memory device of a cellular telephone, the set executable instructions executing on a processor of the cellular telephone written to cause the cellular telephone to pair with the portable device when the portable device is within the predetermined range, wherein pairing comprises an exchange of protocol messages between the cellular telephone and the portable device;
the set of computer instructions written to cause the telephone to ring when pairing is broken between the portable device and the cellular telephone.

2. The system of claim 1 wherein the pairable transceiver is a BLUETOOTH™ transceiver.

3. The system of claim 1 wherein the portable device is contained within a housing constructed to be attached to a key chain.

4. The system of claim 1 wherein the attenuator is chosen to create a free-space range of between 8 and 20 feet.

5. The system of claim 1 further comprising a button on the portable device that causes the pairable transceiver in the portable device to enter a discovery mode.

6. The system of claim 1 wherein the battery is non-rechargeable.

7. The system of claim 1 wherein the battery is rechargeable.

8. The system of claim 7 further comprising a mini-Universal Serial Bus (USB) port for charging the battery.

9. The system of claim 1 further comprising a switch that bypassed the attenuator.

10. A system to prevent leaving a telephone behind comprising:
a portable device that includes:
a housing;
a battery contained in said housing;
a pairable transceiver also contained in said housing, the pairable transceiver being powered by said battery;
an antenna electrically attached to said pairable transceiver through an attenuator, the attenuator chosen to cause the range of the pairable transceiver to be a predetermined distance;
whereby, the pairable transceiver in the portable device pairs with a pairable transceiver in a cellular telephone, wherein pairing comprises an exchange of protocol messages between the cellular telephone and the portable device, and either the cellular telephone or the portable device alarms when pairing is broken.

11. The system of claim 10 wherein the attenuator is chosen to cause the range of the pairable transceiver to be between 8 and 20 feet.

12. The system of claim 10 wherein the cellular telephone alarms when pairing is broken.

13. The system of claim 10 wherein the portable device also includes an enunciator driven by the pairable transceiver, the enunciator alarming upon an electrical signal from the pairable transceiver indicating pairing is broken.

14. The system of claim 10 wherein the housing is constructed to be attached to a key chain.

15. A method for preventing leaving behind a cellular telephone comprising:
providing a portable device containing a pairable transceiver electrically connected with an antenna with a radiated radio signal attenuated so that the pairable transceiver has a predetermined range;
providing a downloadable application for a cellular telephone that causes the cellular telephone to pair with the pairable transceiver in the portable device, wherein pairing comprises an exchange of protocol messages between the cellular telephone and the portable device, and to alarm with a ring tone when that pairing is broken.

16. The method of claim 15 wherein the portable device has a range between 8 and 20 feet.

17. The method of claim 15 wherein the radiated radio signal is attenuated with an attenuator placed between the pairable transceiver and the antenna.

18. The method of claim 15 wherein the portable device has a button that causes the pairable transceiver to enter a discovery mode.

19. The method of claim 15 wherein the portable device is constructed to be attached to a key chain.

20. The method of claim 15 wherein the portable device also contains a rechargeable battery that powers the pairable transceiver.
